(19) United States
(12) Patent Application Publication
(10) Pub. No.: US 2014/0305337 A1
(43) Pub. Date: Oct. 16, 2014

(54) COMPOSITE PIGMENT AND METHOD FOR PRODUCING THE SAME

(71) Applicants: Yukie Suwa, Sakura-shi (JP); Hiroshi Kinoshita, Sakura-shi (JP)

(72) Inventors: Yukie Suwa, Sakura-shi (JP); Hiroshi Kinoshita, Sakura-shi (JP)

(73) Assignee: DIC CORPORATION, Tokyo (JP)

(21) Appl. No.: 14/343,554

(22) PCT Filed: Sep. 6, 2012
(86) PCT No.: PCT/JP2012/072714

§ 371 Date: Jun. 24, 2014

(30) Foreign Application Priority Data
Sep. 9, 2011 (JP) 2011-197081
Dec. 6, 2011 (JP) 2011-275741

(51) Int. Cl. C09B 67/08; C09D 11/00

(52) U.S. Cl. CPC C09B 67/0007; C09B 67/0013; C09D 11/322
USPC 106/31.65; 106/425; 524/432

(57) ABSTRACT

The composite pigment includes a pigment and a zinc oxide particle adhering to a surface of the pigment, and a recording liquid containing the composite pigment. Also, the composite pigment includes a polymer-coated pigment (D) and a zinc oxide particle adhering to a surface of the polymer-coated pigment. The polymer-coated pigment (D) includes a pigment (A) and a (co)polymer obtained either by mixing a (co)polymer (B) of a polymerizable unsaturated monomer with at least one polymerizable unsaturated monomer (C) that is soluble in a non-aqueous solvent and becomes either insoluble or slightly soluble after polymerization, or by copolymerizing a (co)polymer (B) of a polymerizable unsaturated monomer with at least one polymerizable unsaturated monomer (C) that is soluble in a non-aqueous solvent and becomes either insoluble or slightly soluble after polymerization, the (co)polymer being disposed on a surface of the pigment (A).

### TECHNICAL FIELD

The present invention relates to a composite pigment whose hue is not easily changed and which has particularly good light resistance.

### BACKGROUND ART

Organic pigments are widely used as colorants of inks, coating materials, and resins due to their bright hues. However, there may be a problem that the hues are changed by light, in particular, ultraviolet light. In particular, in the cases of applications of organic pigments having small particle diameters, for example, applications to inks for ink-jet printing and applications to color filters, since the transmittance of ultraviolet light also increases, light resistance of the pigments are particularly desired.

A method for precipitating an organic pigment on a surface of an inorganic pigment for the purpose of increasing light resistance of the organic pigment has been disclosed (refer to PTL 1). However, in this method, the resulting pigment composition has a large particle diameter. Therefore, this method is not suitable for applications to inks for ink-jet printing and applications to color filters.

A recording medium in which an organic pigment, a hindered amine light stabilizer, and an inorganic ultraviolet absorber coexist has been disclosed (refer to PTL 2). However, no specific dispersion method is disclosed and the hue of the pigment is changed by using the hindered amine light stabilizer.

### CITATION LIST

### Patent Literature

PTL 1: Japanese Unexamined Patent Application Publication No. 4-132770
PTL 2: Japanese Unexamined Patent Application Publication No. 11-348418

### SUMMARY OF INVENTION

### Technical Problem

An object of the present invention is to provide a composite pigment that has particularly good light resistance.

### Solution to Problem

As a result of intensive studies, the inventors of the present invention found that, by allowing a zinc oxide fine particle to specifically adhere to a surface of a pigment, a composite pigment having an improved light resistance can be obtained without causing a change in the original hue of the pigment.

Furthermore, the inventors of the present invention found that, by allowing a zinc oxide fine particle to specifically adhere to a surface of a polymer-coated pigment prepared by polymerizing a monomer on a surface of a pigment, a composite pigment having an improved light resistance can be obtained.

Specifically, the present invention relates to a composite pigment that includes a pigment and a zinc oxide particle adhering to a surface of the pigment, and a recording liquid that contains the composite pigment.

The present invention relates to a composite pigment including a polymer-coated pigment (D) and a zinc oxide particle adhering to a surface of the polymer-coated pigment. The polymer-coated pigment (D) includes a pigment (A) and a (co)polymer obtained either by mixing a (co)polymer (B) of a polymerizable unsaturated monomer with at least one polymerizable unsaturated monomer (C) that is soluble in a non-aqueous solvent and becomes either insoluble or slightly soluble after polymerization, or by copolymerizing a (co)polymer (B) of a polymerizable unsaturated monomer with at least one polymerizable unsaturated monomer (C) that is soluble in a non-aqueous solvent and becomes either insoluble or slightly soluble after polymerization, the (co)polymer being disposed on a surface of the pigment (A). The present invention also relates to a recording liquid containing the composite pigment.

Furthermore, the present invention relates to a method for producing a composite pigment, the method including allowing a zinc oxide particle to adhere to a surface of a pigment by precipitating the zinc oxide particle by reacting, in the presence of the pigment, a reaction liquid from which zinc oxide is precipitated.

Furthermore, the present invention relates to a method for producing a composite pigment, the method including:

obtaining a polymer-coated pigment (D) by mixing a pigment (A), a non-aqueous solvent, and a (co)polymer (B) of a polymerizable unsaturated monomer, and then polymerizing, in the presence of the pigment (A), the non-aqueous solvent, and the (co)polymer (B) of the polymerizable unsaturated monomer, at least one polymerizable unsaturated monomer (C) that is soluble in the non-aqueous solvent and becomes either insoluble or slightly soluble after polymerization; and

precipitating a zinc oxide fine particle on a surface of the pigment by reacting, in the presence of the polymer-coated pigment (D), a reaction liquid from which zinc oxide is precipitated.

Furthermore, the present invention relates to a method for producing a composite pigment, the method including:

obtaining a polymer-coated pigment (D-1) by mixing a pigment (A), a non-aqueous solvent, and a polymerizable unsaturated group-containing (co)polymer (B-1) of a polymerizable unsaturated monomer, and then copolymerizing the (co)polymer (B-1) of the polymerizable unsaturated monomer with at least one polymerizable unsaturated monomer (C) that is soluble in the non-aqueous solvent and becomes either insoluble or slightly soluble after polymerization; and

precipitating a zinc oxide fine particle on a surface of the pigment by reacting, in the presence of the polymer-coated pigment (D-1), a reaction liquid from which zinc oxide is precipitated.

### Advantageous Effects of Invention

The composite pigment obtained in the present invention has good light resistance and thus can be suitably used in a recording liquid. In addition, since the composite pigment obtained in the present invention has a sufficiently small particle diameter and good light resistance, the composite pigment can be particularly suitably used in applications to inks for ink-jet printing and applications to color filters.

### DESCRIPTION OF EMBODIMENTS

### [Pigment (A)]

A pigment (A) used in the present invention is at least one pigment selected from publicly known and commonly used organic pigments and inorganic pigments. Any of untreated pigments and treated pigments can be applied to the present invention.

Examples of the pigments used in the preparation of the composite pigment include inorganic pigments such as barium sulfate, lead sulfate, titanium oxide, yellow lead, red oxide, chromium oxide, and carbon black; anthraquinone pigments; perylene pigments; disazo pigments; phthalocyanine pigments; isoindoline pigments; dioxazine pigments; quinacridone pigments; perinone pigments; and benzimidazolone pigments. These pigments may be used alone or as a mixture thereof.

As a black pigment, it is preferable to use carbon blacks having a high hiding power, such as furnace black, lamp black, acetylene black, and channel black. Specific examples thereof include Raven 7000, Raven 5750, Raven 5250, Raven 5000 ULTRA II, Raven 3500, Raven 2500 ULTRA, Raven 2000, Raven 1500, Raven 1255, Raven 1250, Raven 1200, Raven 1190 ULTRA II, Raven 1170, Raven 1080 ULTRA, Raven 1060 ULTRA, Raven 790 ULTRA, Raven 780 ULTRA, and Raven 760 ULTRA of which are manufactured by Columbian Carbon Company); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of which are manufactured by Cabot Corporation); Color Black FW1, Color Black FW2, Color Black FW2V, Color Black 18, Color Black FW200, Color Black 5150, Color Black 5160, Color Black 5170, Printex 35, Printex U, Printex V, Printex 140U, Printex 140V, Special Black 6, Special Black 5, Special Black 4A, and Special Black 4 (all of which are manufactured by Degussa); and No. 25, No. 33, No. 40, No. 45, No. 45L, No. 47, No 52, No. 900, No. 960, No. 2300, MCF-88, MA600, MA7, MA8, and MA100 (all of which are manufactured by Mitsubishi Chemical Corporation).

Furthermore, among typical organic pigments of cyan, magenta, and yellow, which are three primary colors of the color, examples of pigments that can be suitably used in the present invention are described below.

Examples of cyan pigments include C. I. Pigment Blue 1, C. I. Pigment Blue 2, C. I. Pigment Blue 3, C. I. Pigment Blue 15, C. I. Pigment Blue 15:1, C. I. Pigment Blue 15:3, C. I. Pigment Blue 15:6, C. I. Pigment Blue 16, C. I. Pigment Blue 22, and C. I. Pigment Blue 60.

Examples of magenta pigments include C. I. Pigment Red 5, C. I. Pigment Red 7, C. I. Pigment Red 12, C. I. Pigment Red 48, C. I. Pigment Red 48:1, C. I. Pigment Red 57, C. I. Pigment Red 112, C. I. Pigment Red 122, C. I. Pigment Red 123, C. I. Pigment Red 146, C. I. Pigment Red 168, C. I. Pigment Red 184, and C. I. Pigment Red 202.

Examples of the yellow pigment include C. I. Pigment Yellow 1, C. I. Pigment Yellow 2, C. I. Pigment Yellow 3, C. I. Pigment Yellow 12, C. I. Pigment Yellow 13, C. I. Pigment Yellow 14, C. I. Pigment Yellow 16, C. I. Pigment Yellow 17, C. I. Pigment Yellow 73, C. I. Pigment Yellow 74, C. I. Pigment Yellow 75, C. I. Pigment Yellow 83, C. I. Pigment Yellow 93, C. I. Pigment Yellow 95, C. I. Pigment Yellow 97, C. I. Pigment Yellow 98, C. I. Pigment Yellow 114, C. I. Pigment Yellow 128, C. I. Pigment Yellow 129, C. I. Pigment Yellow 151, and C. I. Pigment Yellow 154.

Regarding a particle diameter of the pigment (A), the pigment (A) preferably has a primary particle diameter in the range of 1 to 500 nm, and more preferably in the range of 20 to 200 nm. The primary particle diameter of the pigment (A) can be measured by electron microscopy, an adsorption method using a gas or a solute, an air-flow method, an X-ray small-angle scattering method, or the like. The pigment particle diameter after dispersion can be measured by a publicly known and commonly used method such as a centrifugal sedimentation method, a laser diffraction method (light-scattering method), an electro kinetic sonic amplitude (ESA) method, a capillary method, an electron microscope method, or the like. The measurement with a Microtrac UPA using a dynamic light-scattering method is preferable.

### ((Co)Polymer (B) of Polymerizable Unsaturated Monomer)

A (co)polymer (B) of a polymerizable unsaturated monomer used in the present invention is specifically a copolymer of vinyl monomers such as alkyl (meth)acrylates and styrenes. Preferably, the term “(co)polymer (B) of a polymerizable unsaturated monomer” refers to a (co)polymer of a polymerizable unsaturated monomer containing, as a main component, an alkyl (meth)acrylate having an alkyl group having 4 or more carbon atoms, a macromonomer composed of a (co)polymer of a polymerizable unsaturated monomer containing, as a main component, an alkyl (meth)acrylate having an alkyl group having 4 or more carbon atoms, and a styrene polymer, or the like. The (co)polymer (B) of a polymerizable unsaturated monomer is preferably soluble in non-aqueous solvents, but may be dispersed or swollen in non-aqueous solvents.

Examples of the alkyl (meth)acrylate having an alkyl group having 4 or more carbon atoms include n-butyl (meth)acrylate, i-butyl (meth)acrylate, t-butyl (meth)acrylate, 2-ethylhexyl (meth)acrylate, lauryl (meth)acrylate, stearyl (meth)acrylate, isostearyl (meth)acrylate, and cyclohexyl (meth)acrylate.

Examples of the polymerizable unsaturated monomers other than alkyl (meth)acrylates, the polymerizable unsaturated monomers being capable of being used, include aromatic vinyl monomers such as styrene, α-methylstyrene, p-t-butylstyrene, and vinyl toluene; (meth)acrylates such as benzyl (meth)acrylate, dimethylamino (meth)acrylate, diethylamino (meth)acrylate, dibromopropyl (meth)acrylate, and tribromophenyl (meth)acrylate; diesters of an unsaturated dicarboxylic acid such as maleic acid, fumaric acid, or itaconic acid and a monohydric alcohol; and vinyl esters such as vinyl benzoate and “VeoVan” (a vinyl ester manufactured by Royal Dutch Shell, Netherlands). These monomers can be used by copolymerizing with the above alkyl (meth)acrylates. Homopolymers of the polymerizable unsaturated group-containing monomers other than the alkyl (meth)acrylates, the monomers being capable of being used, have low solubility in the non-aqueous media. Therefore, the polymerizable unsaturated monomers other than alkyl (meth)acrylates are preferably used as a random polymer with an alkyl (meth)acrylate. The production of a block copolymer or a graft copolymer is not so preferable because solubility in the non-aqueous media is significantly decreased.

These polymerizable unsaturated monomers may be used alone or in combination of two or more monomers. Among the above monomers, linear or branched alkyl (meth)acrylates having an alkyl group having 4 to 12 carbon atoms, such as n-butyl (meth)acrylate, 2-ethylhexyl (meth)acrylate, and lauryl (meth)acrylate are particularly preferably used.

The (co)polymer of a polymerizable unsaturated monomer containing, as a main component, an alkyl (meth)acrylate having an alkyl group having 4 or more carbon atoms is obtained by polymerizing the polymerizable unsaturated monomer by an ordinary method.

### (Polymerizable Unsaturated Group-Containing (Co)Polymer (B-1) of Polymerizable Unsaturated Monomer)

By introducing a polymerizable unsaturated group in a copolymer of a polymerizable unsaturated monomer containing, as a main component, the alkyl (meth)acrylate having an alkyl group having 4 or more carbon atoms, a more preferable polymerizable unsaturated group-containing (co)polymer (B-1) of a polymerizable unsaturated monomer is obtained.

Examples of a method for introducing a polymerizable unsaturated group include a method including mixing, as the comonomers, carboxyl group-containing polymerizable monomers such as acrylic acid and methacrylic acid or amino group-containing polymerizable monomers such as dimethylaminoethyl methacrylate and dimethylaminopropylacrylamide in advance, copolymerizing the comonomers to prepare the copolymer having a carboxyl group or an amino group, and then allowing a monomer having a glycidyl group and a polymerizable unsaturated group, such as glycidyl methacrylate, to react with the carboxyl group or the amino group; a method including mixing, as the comonomers, hydroxyl group-containing monomers such as 2-hydroxyethyl methacrylate and 2-hydroxyethyl acrylate in advance, copolymerizing the comonomers to prepare the copolymer having a hydroxyl group, and then allowing a monomer having an isocyanate group and a polymerizable unsaturated group, such as isocyanate ethyl methacrylate, to react with the hydroxyl group;

a method including introducing a carboxyl group in an end of a (co)polymer by using thioglycolic acid as a chain transfer agent during polymerization, and allowing a monomer having a glycidyl group and a polymerizable unsaturated group, such as glycidyl methacrylate, to react with the carboxyl group; and
a method including introducing a carboxyl group in a copolymer using, as a polymerization initiator, a carboxyl group-containing azo initiator such as azobis cyanopentanoic acid, and allowing a monomer having a glycidyl group and a polymerizable unsaturated group, such as glycidyl methacrylate, to react with the carboxyl group. Among these methods, the method including copolymerizing carboxyl group-containing monomers such as acrylic acid and methacrylic acid or amino group-containing monomers such as dimethylaminoethyl methacrylate and dimethylaminopropylacrylamide in advance, and allowing a monomer having a glycidyl group and a polymerizable unsaturated group, such as glycidyl methacrylate, to reach with the carboxyl group or the amino group is preferable because this method is the simplest.

Furthermore, styrene copolymers containing styrene as a main component are also preferable. Polystyrene has high solubility in alicyclic hydrocarbon solvents such as cyclohexane. Therefore, polystyrene can be more preferably used in a solvent system that contains an alicyclic hydrocarbon solvent as a main component of a non-aqueous solvent. Copolymers in which a polymerizable unsaturated group is introduced in a styrene copolymer are also preferable. The polymerizable unsaturated group can be introduced by methods similar to those described above.

(Polymerizable Unsaturated Monomer (C) that is Soluble in Non-Aqueous Solvent and Becomes Either Insoluble or Slightly Soluble after Polymerization)

Specific examples of a polymerizable unsaturated monomer (C) that is soluble in a non-aqueous solvent and becomes either insoluble or slightly soluble after polymerization, the polymerizable unsaturated monomer (C) being used in the present invention, include vinyl monomers that do not have a so-called reactive polar group (functional group), such as methyl (meth)acrylate, ethyl (meth)acrylate, n-propyl (meth)acrylate, i-propyl methacrylate, and olefins, e.g., (meth)acrylonitrile, ethylvinylbenzene, vinyl acetate, vinyl chloride, vinylidene chloride, vinyl fluoride, and vinylidene fluoride; amide bond-containing vinyl monomers such as (meth)acrylamide, dimethyl (meth) acrylamide, N-t-butyl(meth)acrylamide, N-octyl (meth)acrylamide, diacetone acrylamide, dimethylaminopropyl acrylamide, and alkoxylated N-methylolated (meth)acrylamides; dialkyl[(meth)acryloyloxyalkyl]phosphates, (meth) acryloyloxyalkyl acid phosphates, dialkyl[(meth)acryloyloxyalkyl]phosphites, and (meth)acryloyloxyalkyl acid phosphites; phosphorus atom-containing vinyl monomers such as alkyleneoxide adducts of the above (meth)acryloyloxyalkyl acid phosphates or acid phosphites, ester compounds of an epoxy group-containing vinyl monomer such as glycidyl (meth)acrylate or methylglycidyl (meth)acrylate and phosphoric acid, phosphorous acid, or an acidic ester thereof, and 3-chloro-2-acid phosphoxypropyl (meth)acrylate; hydroxyl group-containing polymerizable unsaturated monomers such as hydroxyalkyl esters of polymerizable unsaturated carboxylic acids and adducts of any of these and ε-caprolactone, e.g., 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 3-chloro-2-hydroxypropyl (meth)acrylate, di-2-hydroxyethyl fumarate, mono-2-hydroxyethyl monobutyl fumarate, polypropylene glycol or polyethylene glycol mono(meth)acrylate, and “PLACCEL FM or FA Monomer” (caprolactone addition monomer manufactured by Daicel Corporation), polymerizable unsaturated carboxylic acids such as unsaturated mono- and di-carboxylic acids, e.g., (meth)acrylic acid, crotonic acid, maleic acid, fumaric acid, itaconic acid, and citraconic acid, and monoesters of any of these dicarboxylic acids and a monohydric alcohol, adducts of an unsaturated carboxylic acid with a monoepoxy compound such as a monoglycidyl ester of a monovalent carboxylic acid, e.g., “Cardura E”, coconut oil fatty acid glycidyl ester, or octylic acid glycidyl ester, butyl glycidyl ether, ethylene oxide, or propylene oxide, for example, adducts of any of the above polymerizable unsaturated carboxylic acid hydroxyalkyl esters with an anhydride of a polycarboxylic acid such as maleic acid, succinic acid, phthalic acid, hexahydrophthalic acid, tetrahydrophthalic acid, benzene tricarboxylic acid, benzene tetracarboxylic acid, “Himic acid”, tetrachlorophthalic acid, or dodecenyl succinic acid, adducts of any of these with ε-caprolactone, and hydroxy vinyl ether; dialkylaminoalkyl (meth)acrylates such as dimethylaminoethyl (meth)acrylate and diethylaminoethyl (meth)acrylate; epoxy group-containing polymerizable unsaturated monomers such as glycidyl meth(acrylate), (β-methyl)glycidyl (meth)acrylate, and (meth)allyl glycidyl ether, and epoxy group-containing polymerizable compounds obtained by an addition reaction at an equimolar ratio of a polyepoxy compound having at least two epoxy groups in one molecule thereof, such as “EPICLON 200”, “EPICLON 400”, “EPICLON 441”, “EPICLON 850” or “EPICLON 1050” (an epoxy resin manufactured by DIC Corporation], or “Epicoat 828”, “Epicoat 1001” or “Epicoat 1004” (an epoxy resin manufactured by Japan Epoxy Resins Co., Ltd.), “Araldite 6071” or “Araldite 6084” (an epoxy resin manufactured by Ciba-Geigy, Switzerland), “Chissonox 221” [an epoxy compound manufactured by Chisso Corporation], or “Denacol EX-611” [an epoxy compound manufactured by Nagase ChemteX Corporation] with an unsaturated carboxylic acid such as a polymerizable unsaturated carboxylic acid or an equimolar adduct of any of the above polycarboxylic acid anhydrides and a hydroxyl group-containing vinyl monomer such as mono-2-(meth)acryloyloxy monoethyl phthalate; isocyanate group-containing α,β-ethylenically unsaturated monomers such as 2-hydroxyethyl (meth)acrylate-hexamethylene diisocyanate equimolar adduct and monomers having an isocyanate group and a vinyl group such as isocyanateethyl (meth)acrylate; alkoxysilyl group-containing polymerizable unsaturated monomers such as silicon-based monomers, e.g., vinyl ethoxysilane, α-methacryloxypropyltrimethoxysilane, trimethylsiloxyethyl (meth)acrylate, and “KR-215, X-22-5002” (products manufactured by Shin-Etsu Chemical Co., Ltd.); and carboxyl group-containing α,β-ethylenically unsaturated monomers such as α,β-ethylenically unsaturated carboxylic acids, e.g., unsaturated mono- or dicarboxylic acids such as (meth)acrylic acid, crotonic acid, maleic acid, fumaric acid, itaconic acid, and citraconic acid, and monoesters of any of these dicarboxylic acids and a monohydric alcohol, and adducts of an α,β-unsaturated carboxylic acid hydroxyalkyl ester such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 3-chloro-2-hydroxypropyl (meth)acrylate, di-2-hydroxyethyl fumarate, mono-2-hydroxyethyl-monobutyl fumarate, or polyethylene glycol mono(meth)acrylate, and an anhydride of a polycarboxylic acid such as maleic acid, succinic acid, phthalic acid, hexahydrophthalic acid, tetrahydrophthalic acid, benzene tricarboxylic acid, benzene tetracarboxylic acid, “Himic acid”, tetrachlorophthalic acid, or dodecenyl succinic acid.

Among these, alkyl (meth)acrylates having 3 or less carbon atoms, such as methyl (meth)acrylate, ethyl (meth)acrylate, and propyl (meth)acrylate are preferably used. Furthermore, in order to change surface properties of the pigment surface and to enhance the interaction with a pigment dispersant or a resin for pigment dispersion, a polymerizable unsaturated monomer having at least one functional group selected from a carboxyl group, a sulfonic acid group, a phosphoric acid group, a hydroxyl group, a dimethylamino group, and the like is preferably copolymerized.

General-purpose monomers other than the polymerizable unsaturated monomer (C) may be used in combination within a range that does not impair the advantages of the present invention. Examples of such a monomer include the above-described alkyl (meth)acrylates having an alkyl group having 4 or more carbon atoms and the polymerizable unsaturated monomers other than alkyl (meth)acrylates, the polymerizable unsaturated monomers being capable of being used.

In addition, the polymerizable unsaturated monomer (C) more preferably contains, as a component, a monomer that can be partially cross-linked, such as a polyfunctional polymerizable unsaturated monomer from the viewpoint that the pigment does not elute from a coating polymer. Examples of the polyfunctional polymerizable unsaturated monomer include divinylbenzene, ethylene glycol di(meth)acrylate, diethylene glycol di(meth)acrylate, triethylene glycol di(meth)acrylate, polyethylene glycol di(meth)acrylate, 1,3-butanediol di(meth)acrylate, 1,4-butanediol di(meth)acrylate, 1,6-hexanediol di(meth)acrylate, neopentyl glycol dimethacrylate, trimethylolpropane triethoxy tri(meth)acrylate, trimethylolpropane tri(meth)acrylate, pentaerythritol tri(meth)acrylate, pentaerythritol tetra(meth)acrylate, dipentaerythritol hexa(meth)acrylate, and allyl methacrylate.

Out of the polymer-coated pigments (D) of the present invention,

a polymer-coated pigment (D) including a pigment (A), a (co)polymer (B) of a polymerizable unsaturated monomer, and a (co)polymer obtained by polymerizing at least one polymerizable unsaturated monomer (C) that is soluble in a non-aqueous solvent and becomes either insoluble or slightly soluble after polymerization, the (co)polymer (B) and the (co)polymer being disposed on a surface of the pigment (A), is obtained by mixing the pigment (A), a non-aqueous solvent, and the (co)polymer (B) of the polymerizable unsaturated monomer, and then polymerizing, in the presence of the non-aqueous solvent and the (co)polymer (B) of the polymerizable unsaturated monomer, the at least one polymerizable unsaturated monomer (C) that is soluble in the non-aqueous solvent and becomes either insoluble or slightly soluble after polymerization. This polymer-coated pigment (D) includes the pigment (A) and a polymer mixture disposed on a surface of the pigment (A), the polymer mixture being a mixture of the (co)polymer (B) of the polymerizable unsaturated monomer, and a polymer of the at least one polymerizable unsaturated monomer (C) that is soluble in the non-aqueous solvent and becomes either insoluble or slightly soluble after polymerization.

Out of the polymer-coated pigments (D), a polymer-coated pigment (D-1) including a pigment and a copolymer disposed on a surface of the pigment can be obtained by producing the copolymer by copolymerizing a polymerizable unsaturated group-containing (co)polymer (B-1) of a polymerizable unsaturated monomer and at least one polymerizable unsaturated monomer (C) that is soluble in a non-aqueous solvent and becomes either insoluble or slightly soluble after polymerization.

It is preferable to mix the pigment (A) with the (co)polymer (B) of the polymerizable unsaturated monomer prior to the polymerization of the polymerizable unsaturated monomer (C). Examples of the mixing method that can be used include the use of a homogenizer, a Disper, a bead mill, a paint shaker, a kneader, a roll mill, a ball mill, an attritor, a sand mill, or the like. In the present invention, the form of the pigment used is not particularly limited and may be any of a slurry, a wet cake, and a powder. In other words, in the production method of the present invention, even a pigment containing water, which is in the form of a wet cake, can also be used.

After the pigment (A) and the (co)polymer (B) of the polymerizable unsaturated monomer are mixed, the polymerizable unsaturated monomer (C) and a polymerization initiator described below are further mixed, and polymerization is performed. Thus, the polymer-coated pigment (D) is obtained.

In this step, the amount of (co)polymer (B) of the polymerizable unsaturated monomer used is not particularly limited because it is appropriately optimized in accordance with the purpose. The (co)polymer (B) of the polymerizable unsaturated monomer is usually used in an amount of 1 to 200 parts, more preferably 5 to 50 parts, and still more preferably 5 to 30 parts relative to 100 parts of the pigment (A).

The amount of polymerizable unsaturated monomer (C) used is also not particularly limited because it is appropriately optimized in accordance with the purpose. The polymerizable unsaturated monomer (C) is usually used in an amount of 1 to 200 parts, more preferably 5 to 50 parts, and still more preferably 5 to 30 parts relative to 100 parts of the pigment (A).

The amount of (co)polymer (B) of the polymerizable unsaturated monomer used, the (co)polymer (B) finally coating the pigment, is preferably 2 to 400 parts, more preferably 10 to 100 parts, and still more preferably 10 to 60 parts relative to 100 parts of the pigment (A). In this case, the at least one polymerizable unsaturated monomer (C) is usually used in an amount of 10 to 400 parts, preferably 30 to 400 parts, and still more preferably 50 to 200 parts relative to 100 parts of the (co)polymer (B) of the polymerizable unsaturated monomer.

The method for polymerizing the polymerizable unsaturated monomer (C) after the mixing of the pigment (A), the non-aqueous solvent, and the (co)polymer (B) of the polymerizable unsaturated monomer may be a publicly known and commonly used polymerization method. The polymerization is usually conducted in the presence of a polymerization initiator. Examples of the polymerization initiator include radical-generating polymerization catalysts such as azobisisobutyronitrile (AIBN), 2,2-azobis(2-methylbutyronitrile), benzoyl peroxide, t-butyl perbenzoate, t-butyl-2-ethylhexanoate, t-butyl hydroperoxide, di-t-butyl peroxide, and cumene hydroperoxide. These radical-generating polymerization catalysts may be used alone or in combination of two or more thereof.

Since some of the polymerization initiators are difficult to dissolve in the non-aqueous solvent system, a method is preferably used in which a polymerization initiator is dissolved in the polymerizable unsaturated monomer (C), and the resulting solution is then added to the mixed system of the pigment (A), the non-aqueous solvent, and the (co)polymer (B) of the polymerizable unsaturated monomer.

The polymerizable unsaturated monomer (C) or the polymerizable unsaturated monomer (C) in which a polymerization initiator is dissolved may be added by a dropping method in a state where the temperature reaches a polymerization temperature. However, preferably, the polymerizable unsaturated monomer (C) or the polymerizable unsaturated monomer (C) in which a polymerization initiator is dissolved is added in the state of room temperature before the temperature is increased, the temperature is increased after the monomer is sufficiently mixed, and polymerization is then conducted. This method is stable and thus preferable.

The polymerization temperature is usually in the range of 60° C. to 130° C. In the case where the pigment (A) is an organic pigment, a change in the quality of the pigment and a morphological change such as crystal growth may significantly occur at an excessively high polymerization temperature. In such a case, the polymerization is preferably conducted at 70° C. to 100° C.

After the polymerization, the non-aqueous solvent etc. used in the polymerization are removed by filtration, and drying and crushing are further performed. Thus, a polymer-coated pigment can be obtained in the form of a powder. In the filtration method, a Nutsche, a filter press, or the like can be used. Drying can be performed with a publicly known drying apparatus such as a box dryer, a vacuum dryer, a band dryer, or a spray dryer. Furthermore, a publicly known crushing apparatus such as a mortar, a hammer mill, a disk mill, a pin mill, or a jet mill can be used for crushing.

### [Zinc Oxide]

Examples of a method for synthesizing zinc oxide generally include a method including allowing a zinc compound to react with a carbonate compound; a method including allowing a zinc compound to react with an alkali; a method including allowing a zinc compound to react with an alcohol to synthesize a zinc oxide precursor, and allowing the zinc oxide precursor to react with an alkali; and a sol-gel method (alkoxide method). Any method for precipitating zinc oxide may be employed without particular limitation. However, a method including a step of baking or the like is not preferable because a raw material of a pigment is significantly damaged. The method is preferably a solution synthesis method that does not require a baking step. The method is more preferably a low-temperature synthesis method which can synthesize zinc oxide fine particles without damaging a raw material of a pigment.

The zinc compound contained in a zinc ion solution used in the step of allowing a zinc oxide layer to adhere may be any compound that produces a zinc ion in a solvent such as water or an organic solvent. The type of the solvent is not particularly limited, and alcohols and glycols are preferable. Specific examples of the zinc compound include inorganic salts such as zinc sulfate, zinc nitrate, zinc phosphate, and zinc halides such as zinc chloride; organic salts such as zinc formate, zinc acetate, zinc propionate, zinc lactate, zinc oxalate, zinc citrate, zinc tartrate, and zinc acetylacetonate; and hydrates thereof.

Examples of the alkali include lithium hydroxide, sodium hydroxide, potassium hydroxide, lithium carbonate, sodium carbonate, potassium carbonate, sodium hydrogen carbonate, potassium hydrogen carbonate, ammonia, and ammonium carbonate. Among these, sodium hydroxide is particularly preferable.

In the case where a zinc compound is allowed to react with an alkali, any publicly known and commonly used method may be employed. For example, a method for precipitating zinc oxide includes allowing an alkali to react with an alcohol to produce an alkoxide, and allowing the alkoxide to react with a zinc compound. In this case, a ratio of the zinc compound to the alkali may be 1:0.1 or more in terms of molar ratio, and the alkali may be excessively used within a rage that does not impair the advantages of the present invention. Preferably, the molar ratio represented by zinc compound:alkali is in the range of 1:1 to 1:10.

When the ratio of a zinc compound is smaller than 1:0.1, the efficiency is decreased in view of an industrial production method.

In a method for producing a composite pigment, a pigment is mixed with a zinc compound, and an alcohol is added to the mixture. An alkali dissolved in an alcohol is added to the resulting mixture, and allowed to react, thereby precipitating zinc oxide particles on the surface of the pigment. Thus, a composite pigment can be obtained.

In the case where a zinc ion solution and an aqueous alkali solution are prepared in advance and allowed to react with each other, the concentration of each of the solutions is usually 0.01 mmol/L to 1 mol/L. When the concentration is lower than this range, the efficiency is decreased in view of an industrial production method. When the concentration is higher than this range, the degree of supersaturation is high and thus zinc oxide fine particles are aggregated on the surface of the pigment. In addition, since a large number of zinc oxide fine particles are precipitated in the liquid, the hue of the pigment is easily changed.

The zinc ion solution preferably has a concentration of 30 mmol to 100 mol. The aqueous alkali solution preferably has a concentration of 200 mmol to 560 mmol. In the case of these concentrations, zinc oxide fine particles having a particle diameter of 10 nm or less are easily precipitated.

A zinc ion solution and an aqueous alkali ion solution prepared as described above are added to an aqueous slurry solution that contains the pigment (A) and, as required, other additives, and allowed to react with each other. Thus, zinc oxide fine particles are precipitated on the surface of the pigment (A), and a composite pigment can be obtained.

In the case of the production of a composite pigment in which zinc oxide fine particles are precipitated on the surface of the polymer-coated pigment (D) described above, the polymer-coated pigment (D) and a zinc compound are mixed, and an alcohol is added to the mixture. An alkali dissolved in an alcohol is added to the resulting mixture, and allowed to react, thereby precipitating zinc oxide particles on the surface of the polymer-coated pigment (D). Thus, a composite pigment can be obtained.

In the case where a zinc ion solution and an aqueous alkali solution are prepared in advance and allowed to react with each other, the concentration of each of the solutions is usually 0.01 mmol/L to 1 mol/L. When the concentration is lower than this range, the efficiency is decreased in view of an industrial production method. When the concentration is higher than this range, the degree of supersaturation is high and thus zinc oxide fine particles are aggregated on the surface of the pigment. In addition, since a large number of zinc oxide fine particles are precipitated in the liquid, the hue of the pigment is easily changed.

The zinc ion solution preferably has a concentration of 30 mmol to 100 mol. The aqueous alkali solution preferably has a concentration of 200 mmol to 560 mmol. In the case of these concentrations, zinc oxide fine particles having a particle diameter of 10 nm or less are easily precipitated.

A zinc ion solution and an aqueous alkali ion solution prepared as described above are added to an aqueous slurry solution that contains the pigment and, as required, other additives, and allowed to react with each other. Thus, zinc oxide fine particles are precipitated on the surface of the polymer-coated pigment (D), and a composite pigment can be obtained.

The concentration of the zinc oxide particle relative to the pigment (A) is not particularly limited, but is preferably 0.01% by weight to 100% by weight. A concentration of 0.01% by weight or more is preferable because good light resistance is obtained. A concentration of 100% by weight or less is preferable because the hue does not change. The concentration of the zinc oxide particle is more preferably 0.1% by weight to 50% by weight.

The particle diameter of a zinc oxide particle in a composite pigment can be examined by electron microscopy, an adsorption method using a gas or a solute, an air-flow method, an X-ray small-angle scattering method, or the like.

The particle diameter of a zinc oxide particle is preferably 50 nm or less because zinc oxide fine particles uniformly adhere to the surface of the pigment and excellent light resistance is obtained. The particle diameter of a zinc oxide particle is particularly preferably 10 nm or less.

### [Recording Liquid]

The composite pigment of the present invention can be suitably used in a recording liquid, in particular, a water-based ink-jet ink.

According to the composite pigment of the present invention, since the particle diameter of a zinc oxide fine particle is controlled, clogging does not easily occur during ink-jet printing. In addition, since zinc oxide adheres to the surface of the pigment, the composite pigment has good light resistance.

A recording liquid of the present invention is obtained by dispersing the composite pigment of the present invention in an aqueous medium with an aqueous resin by a publicly known and commonly used method, and adding a drying inhibitor, a penetrant, or other additives to the resulting dispersion, as required.

The aqueous resin used in this case is not particularly limited, and a general-purpose liquid vehicle for an ink may be used. The general-purpose vehicle for an ink is preferably a water-based resin. Preferable examples thereof include polyvinyl alcohols; polyvinyl pyrrolidones; (meth)acrylic resins such as methacrylic acid-(meth)acrylic acid ester copolymers; styrene-acrylic resins such as styrene-acrylic acid copolymers, styrene-methacrylic acid copolymers, styrene-methacrylic acid-acrylic acid ester copolymers, styrene-α-methylstyrene-acrylic acid copolymers, and styrene-α-methylstyrene-acrylic acid-acrylic acid ester copolymers; styrene-maleic acid copolymers; styrene-maleic anhydride copolymers; vinyl naphthalene-acrylic acid copolymers; and carboxyl group-containing urethane resins; and salts of these water-based resins.

Examples of compounds for forming salts of the copolymers include lithium hydroxide, sodium hydroxide, potassium hydroxide, ammonia, and organic amines such as diethylamine, ethylamine, triethylamine, propylamine, isopropylamine, dipropylamine, butylamine, isobutylamine, triethanolamine, diethanolamine, aminomethyl propanol, and morpholine. The amount of compound for forming a salt is preferably equal to or larger than the neutralization equivalent of the copolymer.

These water-based resins can be used alone or as a mixture of two or more resins. The form of the water-based resin used here is not particularly limited, and the water-based resin may be a random copolymer, a block copolymer, or the like.

The amount of vehicle for an ink mixed is preferably 1 to 100 parts by mass, and more preferably 2 to 70 parts by mass relative to 100 parts by mass of the composite pigment. The resin for dispersing a pigment preferably has an acid value of 50 to 300 mgKOH/g.

In particular, in the case where an ink for ink-jet printing is prepared, a salt of benzyl methacrylate-(meth)acrylic acid or a styrene-(meth)acrylic acid copolymer is preferably used from the viewpoint that more preferable dispersion stability and the like are obtained. A printed image having a particularly good ink ejection property and good abrasion resistance can be obtained by using an ink prepared by dispersing a composite pigment in water in advance with a salt of benzyl methacrylate-(meth)acrylic acid or a styrene-(meth)acrylic acid copolymer to prepare an aqueous dispersion liquid, and adding a carboxyl group-containing polyurethane to the aqueous dispersion liquid.

### (Aqueous Medium)

The aqueous medium used in the recording liquid of the present invention may be water alone or a mixed solvent of water and a water-soluble organic solvent having compatibility with water. Examples of the water-soluble organic solvent include ketones such as acetone, methyl ethyl ketone, methyl butyl ketone, and methyl isobutyl ketone; alcohols such as methanol, ethanol, 2-propanol, 2-methyl-1-propanol, 1-butanol, and 2-methoxyethanol; ethers such as tetrahydrofuran, 1,4-dioxane, and 1,2-dimethoxyethane; and amides such as dimethylformamide and N-methylpyrrolidone. In particular, at least one compound selected from the group consisting of ketones having 3 to 6 carbon atoms and alcohols having 1 to 5 carbon atoms is preferably used.

The method for obtaining a recording liquid of the present invention, in particular, an ink for ink-jet printing, is not particularly limited, and a publicly known method can be employed. For example, a pigment dispersion liquid prepared by dispersing the composite pigment in water or an aqueous solvent containing water with the above liquid vehicle may be diluted with a solvent without further treatment, and used as an ink.

Publicly known and commonly used dispersing apparatuses such as an ultrasonic homogenizer, a high-pressure homogenizer, a paint shaker, a ball mill, a roll mill, a sand mill, a sand grinder, a Dyno-mill, a Dispermat, an SC mill, and a nanomizer can be used as a stirring/dispersing apparatus for dispersing the pigment.

The recording liquid is prepared by adding a drying inhibitor, a penetrant, or other additives, as required.

The drying inhibitor provides an effect of inhibiting drying of an ink for ink-jet printing in an ink ejection nozzle opening of an ink-jet printer head. In general, a water-soluble organic solvent having a boiling point equal to or higher than the boiling point of water is used.

Examples of the water-soluble organic solvent that can be used as the drying inhibitor include polyhydric alcohols such as ethylene glycol, diethylene glycol, polyethylene glycol, and glycerin; pyrrolidones such as N-methyl-2-pyrrolidone and 2-pyrrolidone; amides; dimethyl sulfoxide; and imidazolidinones. When water is used as a solvent, the drying inhibitor is preferably used in an amount of 1 to 150 parts relative to 100 parts of water.

The penetrant is used in order that an ink for ink-jet printing, the ink being ejected from an ink ejection nozzle of an ink-jet printer head and adhering to a recording medium, is easily penetrated into the recording medium. By using the penetrant, an aqueous solvent is rapidly penetrated into the recording medium and it is possible to obtain recorded matter in which bleeding of an image is suppressed.

Examples of the penetrant used in the present invention include water-soluble organic solvents such as polyhydric alcohols, e.g., ethylene glycol, 1,2,6-hexane triol, thiodiglycol, hexylene glycol, and diethylene glycol; diols, e.g., pentanediol and hexanediol; glycol ethers, e.g., propylene glycol laurate; lower alkyl ethers of polyhydric alcohols, e.g., diethylene glycol ethyl ether and triethylene glycol monoethyl ether; lower alcohols, e.g., ethanol and isopropyl alcohol; glycol ethers, e.g., diethylene glycol-N-butyl ether; and propylene glycol derivatives. These penetrants may be used alone or as a mixture of two or more compounds. By using two or more penetrants as a mixture, more preferable penetrating properties can be obtained in some cases.

A slight amount of surfactant may be added to the recording liquid of the present invention for the purpose of adjusting physical properties such as a surface tension. The surfactant is not particularly limited, and may be appropriately selected from publicly known and commonly used surfactants. Examples of the surfactant include anionic surfactants such as alkylbenzene sulfonates and higher fatty acid salts, nonionic surfactants such as polyoxyethylene alkyl ethers and polyoxyethylene fatty acid esters, cationic surfactants, and amphoteric surfactants. These surfactants may be used alone or as a mixture of two or more surfactants.

Examples of the other additives include antiseptic agents, antifungal agents, and chelating agents for preventing nozzle clogging.

In the case where the recording liquid of the present invention is used as an ink for ink-jet printing, after the dispersion treatment, coarse particles are preferably removed by centrifugal separation, filtration, or the like. The reason for this is that when coarse particles are present in the ink for ink-jet printing, they may cause clogging of an ink ejection nozzle of an ink-jet printer.

### EXAMPLES

The present invention will now be specifically described by using Examples. However, the scope of the present invention is not limited to only these Examples. In the description below, “%” represents “% by mass” and “part” represents “part by mass” unless otherwise stated.

### Reference Example 1

### Synthesis of Copolymer (b-1) of Polymerizable Unsaturated Monomer

In a four-necked flask equipped with a thermometer, a stirrer, a reflux condenser, and a nitrogen gas-introducing tube, 950 parts of butyl acetate was charged, and the temperature was increased to 80° C. At the time when the temperature reached 80° C., a mixture of 970 parts of butyl acrylate, 30 parts of methacrylic acid, and 7 parts of 2,2′-azobis(2-methylbutyronitrile) was added dropwise to the flask over a period of six hours. After the completion of the dropwise addition, the temperature was increased to 90° C., and a reaction was continued at this temperature for 10 hours.

The temperature of the reaction liquid was decreased to 50° C., and a solution prepared by dissolving 0.2 parts of t-butyl pyrocatechol in 20 parts of butyl acetate was added to the reaction liquid. Furthermore, 20 parts of glycidyl methacrylate and 3 parts of dimethylaminoethanol were added thereto. The temperature was then increased to 80° C., and a reaction was conducted at this temperature for 10 hours. Thus, a solution of a polymerizable unsaturated group-containing copolymer (b-1) of a polymerizable unsaturated monomer, the copolymer (b-1), being soluble in a non-aqueous solvent, was prepared.

### Reference Example 2

### Synthesis of Copolymer (b-2) of Polymerizable Unsaturated Monomer

In a four-necked flask equipped with a thermometer, a stirrer, a reflux condenser, and a nitrogen gas-introducing tube, 800 parts of butyl acetate was charged, and the temperature was increased to 80° C. At the time when the temperature reached 80° C., a mixture prepared by dissolving 500 parts of butyl acrylate, 5 parts of dimethylaminoethyl methacrylate, 450 parts of AS-6 (manufactured by Toagosei Co., Ltd.), and 7 parts of 2,2′-azobis(2-methylbutyronitrile) in 200 parts of butyl acetate was added dropwise to the flask over a period of four hours. After the completion of the dropwise addition, the reaction liquid was allowed to react at the same temperature for two hours. The temperature was then increased to 90° C., and the reaction was continued at this temperature for 10 hours.

The temperature of the reaction liquid was decreased to 50° C., and a solution prepared by dissolving 0.2 parts of t-butyl pyrocatechol in 15 parts of butyl acetate was added to the reaction liquid. Furthermore, 15 parts of glycidyl methacrylate was added thereto. The temperature was then increased to 80° C., and a reaction was conducted at this temperature for five hours. Thus, a solution of a polymerizable unsaturated group-containing copolymer (b-2) of a polymerizable unsaturated monomer, the copolymer (b-2) being soluble in a non-aqueous solvent, was prepared.

### Reference Example 3

### Synthesis of Copolymer (b-3) of Polymerizable Unsaturated Monomer

In a four-necked flask equipped with a thermometer, a stirrer, a reflux condenser, and a nitrogen gas-introducing tube, 922 parts of butyl acetate was charged, and the temperature was increased to 100° C. At the time when the temperature reached 100° C., a mixture prepared by dissolving 538 parts of styrene, 7 parts of butyl acrylate, 91 parts of methacrylic acid, 7 parts of acrylic acid, 30 parts of AS-6 (manufactured by Toagosei Co., Ltd.), and 7 parts of 2,2′-azobis(2-methylbutyronitrile) in 300 parts of butyl acetate was added dropwise to the flask over a period of three hours. After the completion of the dropwise addition, a reaction was conducted while the same temperature was maintained for seven hours. Thus, a solution of a copolymer (b-3) of a polymerizable unsaturated monomer that was soluble in a non-aqueous solvent was prepared.

### Reference Example 4

### Synthesis of Polymer-Coated Pigment (d-1)

In a polyethylene wide-mouth bottle, 30 parts of C. I. Pigment Yellow 74, 3.0 parts of the copolymer (b-1) prepared in Reference Example 1, 180 parts of zirconia beads of 1.25 mm, and 150 parts of heptane were put and mixed with a paint shaker (Toyo Seiki Seisaku-sho, Ltd.) for 90 minutes. The resulting mixture was diluted with 35 parts of heptane, and the zirconia beads were then removed. Thus, a pigment mixed liquid was prepared.

In a separable flask equipped with a thermometer, a stirrer, a reflux condenser, and a nitrogen gas-introducing tube, 200 parts of the pigment mixed liquid was charged. Subsequently, a solution prepared by dissolving 0.6 parts of 2,2′-azobis(2-methylbutyronitrile) in a polymerizable monomer composition containing 1.8 parts of methyl methacrylate and 1.0 part of ethylene glycol dimethacrylate, and 40 parts of heptane were added to the flask. Stirring was continued at room temperature for 30 minutes. Subsequently, the temperature was increased to 80° C., and a reaction was continued at this temperature for 15 hours. After the temperature was decreased, the resulting polymer-treated pigment and the polymerization solvent were separated from each other by filtration. The resulting polymer pigment was dried with a hot-air dryer at 100° C. for five hours, and then crushed with an Absolute mill. Thus, a polymer-coated pigment (d-1) was prepared.

### Reference Example 5

### Synthesis of Polymer-Coated Pigment (d-2)

In a polyethylene wide-mouth bottle, 20 parts of C. I. Pigment Yellow 74, 4.0 parts of the copolymer (b-2) prepared in Reference Example 1, 120 parts of zirconia beads of 1.25 mm, and 100 parts of heptane were put and mixed with a paint shaker (Toyo Seiki Seisaku-sho, Ltd.) for 90 minutes. The resulting mixture was diluted with 21 parts of heptane, and the zirconia beads were then removed. Thus, a pigment mixed liquid was prepared.

In a separable flask equipped with a thermometer, a stirrer, a reflux condenser, and a nitrogen gas-introducing tube, 139 parts of the pigment mixed liquid was charged. Subsequently, a solution prepared by dissolving 0.4 parts of 2,2′-azobis(2-methylbutyronitrile) in a polymerizable monomer composition containing 1.3 parts of methyl methacrylate and 0.7 parts of ethylene glycol dimethacrylate, and 20 parts of heptane were added to the flask. Stirring was continued at room temperature for 30 minutes. Subsequently, the temperature was increased to 80° C., and a reaction was continued at this temperature for 15 hours. After the temperature was decreased, the resulting polymer-treated pigment and the polymerization solvent were separated from each other by filtration. The resulting polymer pigment was dried with a hot-air dryer at 100° C. for five hours, and then crushed with an Absolute mill. Thus, a polymer-coated pigment (d-2) was prepared.

### Reference Example 6

### Synthesis of Polymer-Coated Pigment (d-3)

In a polyethylene wide-mouth bottle, 20 parts of C. I. Pigment Yellow 74, 4.0 parts of the copolymer (b-2) prepared in Reference Example 1, 120 parts of zirconia beads of 1.25 mm, and 150 parts of heptane were put and mixed with a paint shaker (Toyo Seiki Seisaku-sho, Ltd.) for 90 minutes. The resulting mixture was diluted with 23 parts of heptane, and the zirconia beads were then removed. Thus, a pigment mixed liquid was prepared.

In a separable flask equipped with a thermometer, a stirrer, a reflux condenser, and a nitrogen gas-introducing tube, 143 parts of the pigment mixed liquid was charged. Subsequently, a solution prepared by dissolving 0.4 parts of 2,2′-azobis(2-methylbutyronitrile) in a polymerizable monomer composition containing 1.1 parts of divinylbenzene and 0.9 parts of ethylvinyibenzene, and 20 parts of heptane were added to the flask. Stirring was continued at room temperature for 30 minutes. Subsequently, the temperature was increased to 80° C., and a reaction was continued at this temperature for 15 hours. After the temperature was decreased, the resulting polymer-treated pigment and the polymerization solvent were separated from each other by filtration. The resulting polymer pigment was dried with a hot-air dryer at 100° C. for five hours, and then crushed with an Absolute mill. Thus, a polymer-coated pigment (d-3) was prepared.

### Reference Example 7

### Synthesis of Polymer-Coated Pigment (d-4)

In a polyethylene wide-mouth bottle, 50 parts of C. I. Pigment Yellow 74, 5.5 parts of the copolymer (b-3) prepared in Reference Example 1, 200 parts of zirconia beads of 1.25 mm, and 220 parts of cyclohexane were put and mixed with a paint shaker (Toyo Seiki Seisaku-sho, Ltd.) for 90 minutes. The resulting mixture was diluted with 177 parts of cyclohexane, and the zirconia beads were then removed. Thus, a pigment mixed liquid was prepared.

In a separable flask equipped with a thermometer, a stirrer, a reflux condenser, and a nitrogen gas-introducing tube, 440 parts of the pigment mixed liquid was charged. Subsequently, a solution prepared by dissolving 1.0 part of 2,2′-azobis(2-methylbutyronitrile) in a polymerizable monomer composition containing 2.4 parts of methyl methacrylate and 2.4 parts of ethylene glycol dimethacrylate was added to the flask. Stirring was continued at room temperature for 30 minutes. Subsequently, the temperature was increased to 80° C., and a reaction was continued at this temperature for 15 hours. After the temperature was decreased, the resulting polymer-treated pigment and the polymerization solvent were separated from each other by filtration. The resulting polymer pigment was dried with a hot-air dryer at 100° C. for five hours, and then crushed with an Absolute mill. Thus, a polymer-coated pigment (d-4) was prepared.

### Reference Example 8

### Synthesis of Polymer-Coated Pigment (d-5)

In a polyethylene wide-mouth bottle, 50 parts of C. I. Pigment Yellow 74, 5.5 parts of the copolymer (b-3) prepared in Reference Example 1, 200 parts of zirconia beads of 1.25 mm, and 220 parts of cyclohexane were put and mixed with a paint shaker (Toyo Seiki Seisaku-sho, Ltd.) for 90 minutes. The resulting mixture was diluted with 180 parts of cyclohexane, and the zirconia beads were then removed. Thus, a pigment mixed liquid was prepared.

In a separable flask equipped with a thermometer, a stirrer, a reflux condenser, and a nitrogen gas-introducing tube, 443 parts of the pigment mixed liquid was charged. Subsequently, a solution prepared by dissolving 1.1 parts of 2,2′-azobis(2-methylbutyronitrile) in a polymerizable monomer composition containing 1.5 parts of methyl methacrylate, 1.5 parts of ethylene glycol dimethacrylate, and 2.7 parts of 3-methacryloxypropyltriethoxysilane was added to the flask. Stirring was continued at room temperature for 30 minutes. Subsequently, the temperature was increased to 80° C., and a reaction was continued at this temperature for 15 hours. After the temperature was decreased, the resulting polymer-treated pigment and the polymerization solvent were separated from each other by filtration. The resulting polymer pigment was dried with a hot-air dryer at 100° C. for five hours, and then crushed with an Absolute mill. Thus, a polymer-coated pigment (d-5) was prepared.

### Reference Example 9

### Synthesis of Resin for Dispersion

In a reaction vessel equipped with a stirring device, a dropping device, and a reflux device, 100 parts of methyl ethyl ketone was charged, and the atmosphere in the reaction vessel was replaced with nitrogen while stirring. The reaction vessel was heated while the nitrogen atmosphere in the reaction vessel was maintained so that methyl ethyl ketone was in a reflux state. Subsequently, a mixed liquid of 74 parts of styrene, 11 parts of acrylic acid, 15 parts of methacrylic acid, and 8 parts of a polymerization catalyst (“V-59”, manufactured by Wako Pure Chemical Industries, Ltd.) was added dropwise from the dropping device over a period of two hours. In the course of the dropwise addition, the temperature of the reaction system was maintained at 80° C.

After the completion of the dropwise addition, a reaction was further continued at the same temperature for 25 hours. In the course of the reaction, the polymerization catalyst was added as required while observing the state of the consumption of the raw material. After the completion of the reaction, methyl ethyl ketone was distilled off under a reduced pressure, and the resulting solid was crushed. Thus, a powder of a styrene-acrylic acid-based copolymer (A-1) was obtained.

Through the above steps, a styrene-acrylic acid-based resin (A-1) having a ratio of styrene/acrylic acid/methacrylic acid=74/11/15 (% by weight), a weight-average molecular weight of 9,000, and an acid value of 185 mgKOH/g was obtained.

### Example 1

### Production of Composite Pigment

In a 1-L flask, 15 parts of C. I. Pigment Yellow 74 serving as a pigment, 4.0 parts of zinc acetylacetonate, and 250 parts of ethanol were charged, and the temperature was increased to 80° C. while stirring. A sodium hydroxide solution prepared by dissolving 1.5 parts of sodium hydroxide (in an amount of two times the number of moles of zinc acetylacetonate) in 70 parts of ethanol was added to the flask at a rate at which the liquid temperature of the reaction liquid did not substantially change. The reaction liquid was allowed to react at 80° C. for four hours. After the completion of the reaction, filtration was performed by using filter paper. The resulting reaction product was washed with water and methanol, and then dried with a hot-air dryer at 100° C. for six hours. The dried product was crushed with an Absolute mill. Thus, Composite pigment 1 in which zinc oxide particles adhered to the surface of the pigment was prepared.

### [Production of Recording Liquid]

In a 100-mL plastic bottle, 4.0 parts of Composite pigment 1 prepared above, 1.2 parts of the styrene-acrylic acid-based copolymer (A-1) serving as a dispersant, 2.0 parts of triethylene glycol monobutyl ether, 4.4 parts of a 5% aqueous potassium hydroxide solution, 8.4 parts of ion exchange water, and zirconia beads having a diameter of 0.5 mm were charged and mixed. The resulting mixed liquid was dispersed with a paint conditioner for two hours. After the completion of the dispersion, 13.0 parts of ion exchange water was added to the resulting dispersion liquid, and the zirconia beads were removed. The liquid was subjected to centrifugal separation (6,000 G, 30 minutes) to remove coarse particles. Thus, Water-based pigment dispersion 1 was prepared. Next, 5.4 parts of Water-based pigment dispersion 1 prepared above, 2.3 parts of glycerin, 1.2 parts of triethylene glycol monobutyl ether, 0.15 parts of Surfinol 465 (manufactured by Air Products and Chemicals, Inc.), and 6.0 parts of ion exchange water were mixed to prepare Recording liquid 1.

### Examples 2 to 5

Composite pigments 2 to 5 of Examples 2 to 5 were prepared as in Example 1 except that the amount of zinc acetylacetonate, the amount of sodium hydroxide, and the amount of ethanol were changed as shown in Table 1. Dispersions were prepared by using the pigments and Recording liquids 2 to 5 were prepared as shown in Table 2.

Table 1 shows the synthesis conditions of the composite pigments prepared in Examples 1 to 5. Table 2 shows the amounts mixed and evaluation results of the recording liquids prepared in Examples 1 to 5.

### Comparative Example 1

In a 100-mL plastic bottle, 4.0 parts of C. I. Pigment Yellow 74, 1.2 parts of the copolymer A-1 serving as a dispersant, 4.4 parts of a 5% aqueous potassium hydroxide solution, 2.0 parts of triethylene glycol monobutyl ether, 8.4 parts of ion exchange water, and zirconia beads having a diameter of 0.5 mm were charged and mixed. The resulting mixed liquid was dispersed with a paint conditioner for two hours. After the completion of the dispersion, 13.0 parts of ion exchange water was added to the resulting dispersion liquid, and the zirconia beads were removed. The liquid was subjected to centrifugal separation (6,000 G, 30 minutes) to remove coarse particles. Thus, Comparative water-based pigment dispersion 1 was prepared. Next, 5.0 parts of Comparative water-based pigment dispersion 1 prepared above, 2.3 parts of glycerin, 1.2 parts of triethylene glycol monobutyl ether, 0.15 parts of Surfinol 465 (manufactured by Air Products and Chemicals, Inc.), and 6.5 parts of ion exchange water were mixed to prepare Comparative recording liquid 1.

### Comparative Example 2

In a 100-mL plastic bottle, 3.6 parts of C. I. Pigment Yellow 74, 0.4 parts of zinc oxide (FINEX 50, manufactured by Sakai Chemical Industry Co., Ltd.), 1.2 parts of the copolymer A-1 serving as a dispersant, 4.4 parts of a 5% aqueous potassium hydroxide solution, 2.0 parts of triethylene glycol monobutyl ether, 8.4 parts of ion exchange water, and zirconia beads having a diameter of 0.5 mm were charged and mixed. The resulting mixed liquid was dispersed with a paint conditioner for two hours. After the completion of the dispersion, 13.0 parts of ion exchange water was added to the resulting dispersion liquid, and the zirconia beads were removed. The liquid was subjected to centrifugal separation (6,000 G, 30 minutes) to remove coarse particles. Thus, Comparative water-based pigment dispersion 2 was prepared. Next, 5.2 parts of Comparative water-based pigment dispersion 2 prepared above, 2.3 parts of glycerin, 1.2 parts of triethylene glycol monobutyl ether, 0.15 parts of Surfinol 465 (manufactured by Air Products and Chemicals, Inc.), and 4.8 parts of ion exchange water were mixed to prepare Comparative recording liquid 2.

### Comparative Example 3

Comparative water-based pigment dispersion 3 was prepared as in Comparative Example 2 except that the amount of C. I. Pigment Yellow 74 was changed to 3.2 parts, and the amount of zinc oxide was changed to 0.8 parts. Next, 6.2 parts of Comparative water-based pigment dispersion 3 prepared above, 2.3 parts of glycerin, 1.1 parts of triethylene glycol monobutyl ether, 0.15 parts of Surfinol 465 (manufactured by Air Products and Chemicals, Inc.), and 5.3 parts of ion exchange water were mixed to prepare Comparative recording liquid 3.

### Comparative Example 4

In a 100-mL plastic bottle, 4 parts of zinc oxide (FINEX 50, manufactured by Sakai Chemical Industry Co., Ltd.), 1.2 parts of the copolymer A-1 serving as a dispersant, 4.4 parts of a 5% aqueous potassium hydroxide solution, 2.0 parts of triethylene glycol monobutyl ether, 8.4 parts of ion exchange water, and zirconia beads having a diameter of 0.5 mm were charged and mixed. The resulting mixed liquid was dispersed with a paint conditioner for two hours. After the completion of the dispersion, 13 parts of ion exchange water was added to the resulting dispersion liquid, and the zirconia beads were removed. The liquid was subjected to centrifugal separation (6,000 G, 30 minutes) to remove coarse particles. Thus, a 12% zinc oxide dispersion liquid was prepared. Next, 0.4 parts of the 12% zinc oxide dispersion liquid, 5.0 parts of Comparative water-based pigment dispersion 1 prepared in Comparative Example 1, 2.3 parts of glycerin, 1.2 parts of triethylene glycol monobutyl ether, 0.15 parts of Surfinol 465 (manufactured by Air Products and Chemicals, Inc.), and 6.0 parts of ion exchange water were mixed to prepare Comparative recording liquid 4.

### Comparative Example 5

Comparative recording liquid 5 was prepared as in Comparative Example 4 except that the amount of 12% zinc oxide dispersion liquid was changed to 1.1 parts.

Table 2 shows the amounts mixed and evaluation results of the recording liquids prepared in Comparative Examples 1 to 5.

TABLE 1

| | | | Example 1 | Example 2 | Example 3 | Example 4 | Example 5 |
|---|---|---|---|---|---|---|---|
| Pigment | Type | | PY74 | PY74 | PY74 | PY74 | PY74 |
| | Amount mixed | | 15 | 12 | 10 | 10 | 10 |
| Zinc oxide | Zinc | Type | Zinc | Zinc | Zinc | Zinc | Zinc |
| | | | acetyl- | acetyl- | acetyl- | acetyl- | acetyl- |
| | | | acetonate | acetonate | acetonate | acetonate | acetonate |
| | | Amount | 4.0 | 7.9 | 9.7 | 13.0 | 16.2 |
| | | mixed | | | | | |
| | | Type | Ethanol | Ethanol | Ethanol | Ethanol | Ethanol |
| | | Amount | 250 | 330 | 380 | 430 | 550 |
| | | mixed | | | | | |
| | Alkali | Type | Sodium | Sodium | Sodium | Sodium | Sodium |
| | | | hydroxide | hydroxide | hydroxide | hydroxide | hydroxide |
| | | Amount | 1.5 | 2.6 | 3.3 | 4.2 | 5.3 |
| | | mixed | | | | | |
| | | Type | Ethanol | Ethanol | Ethanol | Ethanol | Ethanol |
| | | Amount | 70 | 108 | 127 | 165 | 210 |
| | | mixed | | | | | |

| | | | | | | |
|---|---|---|---|---|---|---|
| Composite | Name | Composite | Composite | Composite | Composite | Composite |
| pigment | | pigment 1 | pigment 2 | pigment 3 | pigment 4 | pigment 5 |
| | Zinc oxide/pigment | 10% | 20% | 30% | 40% | 50% |

TABLE 2

| | | Example 1 | Example 2 | Example 3 | Example 4 | Example 5 |
|---|---|---|---|---|---|---|
| Composition | Composite | Composite | Composite | Composite | Composite | Composite |
| | pigment | pigment 1 | pigment 2 | pigment 3 | pigment 4 | pigment 5 |
| | | 4.0 | 4.0 | 4.0 | 4.0 | 4.0 |
| | Resin for | 1.2 | 1.2 | 1.2 | 1.2 | 1.2 |
| | dispersion | | | | | |
| | (A-1) | | | | | |
| | Triethylene | 2.0 | 2.0 | 2.0 | 2.0 | 2.0 |
| | glycol | | | | | |
| | monobutyl | | | | | |
| | ether | | | | | |
| | 5% Aqueous | 4.4 | 4.4 | 4.4 | 4.4 | 4.4 |
| | potassium | | | | | |
| | hydroxide | | | | | |
| | solution | | | | | |
| | Ion exchange | 21.4 | 21.4 | 21.4 | 21.4 | 21.4 |
| | water | | | | | |
| Water-based | N.V. | 16.4 | 15.6 | 15.4 | 16.8 | 16.7 |
| pigment | Name | Water- | Water- | Water- | Water- | Water- |
| dispersion | | based | based | based | based | based |
| | | pigment | pigment | pigment | pigment | pigment |
| | | dispersion 1 | dispersion 2 | dispersion 3 | dispersion 4 | dispersion 5 |
| Recording | Water-based | 5.4 | 6.2 | 6.8 | 6.7 | 7.3 |
| liquid | pigment | | | | | |
| | dispersion | | | | | |
| | Glycerin | 2.3 | 2.3 | 2.3 | 2.3 | 2.3 |
| | Triethylene | 1.2 | 1.1 | 1.1 | 1.1 | 1.0 |
| | glycol | | | | | |
| | monobutyl | | | | | |
| | ether | | | | | |
| | Surfinol 465 | 0.15 | 0.15 | 0.15 | 0.15 | 0.15 |
| | Ion exchange | 6.0 | 5.3 | 4.7 | 4.8 | 4.3 |
| | water | | | | | |
| | Name | Recording | Recording | Recording | Recording | Recording |
| | | liquid 1 | liquid 2 | liquid 3 | liquid 4 | liquid 5 |
| Pigment | Pigment | 37 nm | 38 nm | 43 nm | 26 nm | 30 nm |
| composition | particle | | | | | |
| | diameter | | | | | |
| | Zinc oxide | 9.3 nm | 9.0 nm | 8.7 nm | 9.0 nm | 11.0 nm |
| | particle | | | | | |
| | diameter | | | | | |
| Evaluation of | Difference in | 29.1 | 23.9 | 34.5 | 38.1 | 30.6 |
| light resistance | ΔE | | | | | |
| | Evaluation | A | A | A | A | A |

TABLE 3

| | | Comparative | Comparative | Comparative | Comparative | Comparative |
|---|---|---|---|---|---|---|
| | | Example 1 | Example 2 | Example 3 | Example 4 | Example 5 |
| Water-based | Pigment (PY74) | 4.0 | 3.6 | 3.2 | 4.0 | 4.0 |
| pigment | Zinc oxide | — | FINEX 50 | FINEX 50 | — | — |
| dispersion | | | 0.4 | 0.8 | | |
| | Resin for | 1.2 | 1.2 | 1.2 | 1.2 | 1.2 |
| | dispersion | | | | | |
| | (A-1) | | | | | |
| | Triethylene | 2.0 | 2.0 | 2.0 | 2.0 | 2.0 |
| | glycol | | | | | |
| | monobutyl ether | | | | | |
| | 5% Aqueous | 4.4 | 4.4 | 4.4 | 4.4 | 4.4 |
| | potassium | | | | | |
| | hydroxide | | | | | |
| | solution | | | | | |
| | Ion exchange | 21.4 | 21.4 | 21.4 | 21.4 | 21.4 |
| | water | | | | | |
| Water-based | N.V. | 16.4 | 17.4 | 16.3 | 16.4 | 16.4 |
| pigment | Name | Comparative | Comparative | Comparative | Comparative | Comparative |
| dispersion | | water-based | water-based | water-based | water-based | water-based |
| | | pigment | pigment | pigment | pigment | pigment |
| | | dispersion 1 | dispersion 2 | dispersion 3 | dispersion 1 | dispersion 1 |
| Recording | Water-based | 5.0 | 5.2 | 6.2 | 5.0 | 4.9 |
| liquid | pigment | | | | | |
| | dispersion | | | | | |
| | 12% Zinc oxide | — | — | — | 0.4 | 1.1 |
| | dispersion liquid | | | | | |
| | Glycerin | 2.3 | 2.3 | 2.3 | 2.3 | 2.3 |
| | Triethylene | 1.2 | 1.2 | 1.1 | 1.2 | 1.2 |
| | glycol | | | | | |
| | monobutyl ether | | | | | |
| | Surfinol 465 | 0.15 | 0.15 | 0.15 | 0.15 | 0.15 |
| | Ion exchange | 6.5 | 4.8 | 5.3 | 6.0 | 5.5 |
| | water | | | | | |
| | Name | Comparative | Comparative | Comparative | Comparative | Comparative |
| | | recording | recording | recording | recording | recording |
| | | liquid 1 | liquid 2 | liquid 3 | liquid 4 | liquid 5 |
| Pigment | Pigment particle | 40 nm | 40 nm | 40 nm | 40 nm | 40 nm |
| composition | diameter | | | | | |
| | Zinc oxide | — | 20 nm | 20 nm | 20 nm | 20 nm |
| | particle | | | | | |
| | diameter | | | | | |
| | Zinc oxide/ | 0% | 11% addition | 25% addition | 10% addition | 20% addition |
| | pigment | | | | | |
| Evaluation of | Difference in | 0 | 14 | 14.3 | 6.2 | 0.1 |
| light | ΔE | | | | | |
| resistance | Evaluation | D | C | C | D | D |

### Evaluation/Measurement Methods

### [Method for Measuring Particle Diameters of Pigment and Zinc Oxide]

Primary particle diameters of pigments and zinc oxide of the composite pigments synthesized in Examples 1 to 3 were calculated by small-angle X-ray scattering using an X-ray diffractometer (TTRII, manufactured by Rigaku Corporation) (analysis software, rigaku NANO-Solver).

In Composite pigment 1, the composite pigment had a particle diameter of 37 nm and zinc oxide had a particle diameter of 9.3 nm.

In Composite pigment 2, the composite pigment had a particle diameter of 38 nm and zinc oxide had a particle diameter of 9.0 nm.

In Composite pigment 3, the composite pigment had a particle diameter of 43 nm and zinc oxide had a particle diameter of 8.7 nm.

In Composite pigment 4, the composite pigment had a particle diameter of 26 nm and zinc oxide had a particle diameter of 9.0 nm.

In Composite pigment 3, the composite pigment had a particle diameter of 30 nm and zinc oxide had a particle diameter of 11.0 nm.

### [Evaluation of Light Resistance]

Printing was conducted with an ink-jet printer by using the recording liquids prepared in Examples 1 to 5 and recording liquids prepared in Comparative Examples 1 to 5. A drawing was printed on a recording medium with a piezo ink-jet printer (PX-G930, manufactured by Seiko Epson Corporation) by using the ink samples. “Glossy Photo Paper” manufactured by Seiko Epson Corporation was used as the recording medium. The hue of the printed matter was measured with a spectrophotometer (SpectroEye, a product manufactured by GretagMacbeth). Regarding the measurement mode, a light source of D50, an absolute white base, an observation field of view of 2°, no filter, and a density standard of DIN NB were used.

The prepared printed matter was irradiated with ultraviolet light for 144 hours by using a light resistance tester (SUNTEST CPS+, manufactured by Atlas Material Testing Solutions, xenon lamp, irradiation intensity: 765 W/m²). Subsequently, the hue of the printed matter was measured again by the same method. A color difference (ΔE*ab) was calculated from the above results.

The superiority and inferiority of light resistance was determined as follows. Comparative Example 1 had the lowest light resistance and thus had the largest ΔE. Accordingly, the light resistance was determined as a difference in ΔE from Comparative Example 1 (ΔE (Comparative Example 1)−ΔE (sample)) by using ΔE of Comparative Example 1 as a standard. The larger the difference in ΔE, the better the light resistance and the smaller the change in the hue from the time of the start of the light resistance test. When the difference in ΔE was 20 or more, the sample was evaluated as “A”. When the difference in ΔE was 15 or more and less than 20, the sample was evaluated as “B”. When the difference in ΔE was 10 or more and less than 15, the sample was evaluated as “C”. When the difference in ΔE was less than 10, the sample was evaluated as “D”.

### Example 6

### Production of Composite Pigment

In a 1-L flask, 17.3 parts of the polymer-coated pigment (d-1) serving as a pigment, 4.9 parts of zinc acetylacetonate, and 250 parts of ethanol were charged, and the temperature was increased to 80° C. while stirring. A sodium hydroxide solution prepared by dissolving 1.5 parts of sodium hydroxide (in an amount of two times the number of moles of zinc acetylacetonate) in 67 parts of ethanol was added to the flask at a rate at which the liquid temperature of the reaction liquid did not substantially change. The reaction liquid was allowed to react at 80° C. for four hours. After the completion of the reaction, filtration was performed by using filter paper. The resulting reaction product was washed with water and methanol, and then dried with a hot-air dryer at 100° C. for six hours. The dried product was crushed with an Absolute mill. Thus, Composite pigment 6 in which zinc oxide particles adhered to the surface of the pigment was prepared.

### Examples 7 to 14

Composite pigments 7 to 14 of Examples 7 to 14 were prepared as in Example 6 except that the polymer-coated pigment, the amount of zinc acetylacetonate, the amount of sodium hydroxide, and the amount of ethanol were changed as shown in Table 4.

Table 4 shows the synthesis conditions of the composite pigments prepared in Examples 6 to 14.

TABLE 4

| | | | | | | | Example | Example | Example | Example | Example |
|---|---|---|---|---|---|---|---|---|---|---|---|
| | | | Example 6 | Example 7 | Example 8 | Example 9 | 10 | 11 | 12 | 13 | 14 |
| Polymer- | Type | | d-1 | d-2 | d-3 | d-4 | d-4 | d-4 | d-5 | d-5 | d-5 |
| coated | Amount mixed | | 17.3 | 17.4 | 17.3 | 17.3 | 14.0 | 11.5 | 17.4 | 14.0 | 11.5 |
| pigment | | | | | | | | | | | |
| Zinc oxide | Zinc | Zinc | 4.9 | 4.9 | 4.9 | 4.9 | 7.9 | 9.7 | 4.9 | 7.9 | 9.7 |
| | | acetyl- | | | | | | | | | |
| | | acetonate | | | | | | | | | |
| | | Ethanol | 250 | 250 | 250 | 250 | 330 | 380 | 250 | 300 | 380 |
| | Alkali | Sodium | 1.5 | 1.5 | 1.5 | 1.5 | 2.6 | 3.2 | 1.5 | 2.7 | 3.2 |
| | | hydroxide | | | | | | | | | |
| | | Ethanol | 67 | 67 | 67 | 67 | 106 | 130 | 60 | 106 | 126 |

| | | | | | | | | | | |
|---|---|---|---|---|---|---|---|---|---|---|
| Composite | Name | Composite | Composite | Composite | Composite | Composite | Composite | Composite | Composite | Composite |
| pigment | | pigment 6 | pigment 7 | pigment 8 | pigment 9 | pigment | pigment | pigment | pigment | pigment |
| | | | | | | 10 | 11 | 12 | 13 | 14 |
| | Composite pigment | 48 nm | 50 nm | 47 nm | 46 nm | 51 nm | 51 nm | 44 nm | 51 nm | 48 nm |
| | particle diameter | | | | | | | | | |
| | Zinc oxide particle | 7.8 nm | 8.9 nm | 9.0 nm | 5.5 nm | 6.9 nm | 7.6 nm | 5.5 nm | 5.4 nm | 5.6 nm |
| | diameter | | | | | | | | | |
| | Zinc oxide/pigment | 10% | 10% | 10% | 10% | 20% | 30% | 10% | 20% | 30% |

### Example 15

### Production of Recording Liquid

In a 100-mL plastic bottle, 4 parts of Composite pigment 9 prepared above, 1.2 parts of the copolymer A-1 serving as a resin for dispersion, 2.0 parts of triethylene glycol monobutyl ether, 4.4 parts of a 5% aqueous potassium hydroxide solution, 8.4 parts of ion exchange water, and zirconia beads having a diameter of 0.5 mm were charged and mixed. The resulting mixed liquid was dispersed with a paint conditioner for two hours. After the completion of the dispersion, 13.0 parts of ion exchange water was added to the resulting dispersion liquid, and the zirconia beads were removed. The liquid was subjected to centrifugal separation (6,000 G, 30 minutes) to remove coarse particles. Thus, Water-based pigment dispersion 6 was prepared. Next, 6.2 parts of Water-based pigment dispersion 6 prepared above, 2.3 parts of glycerin, 1.1 parts of triethylene glycol monobutyl ether, 0.15 parts of Surfinol 465 (manufactured by Air Products and Chemicals, Inc.), and 5.3 parts of ion exchange water were mixed to prepare Recording liquid 6.

### Examples 16 to 19

Dispersions were prepared as in Example 15 as shown in Table 2, and Recording liquids 2 to 5 were prepared.

Table 5 shows the amounts mixed and evaluation results of the recording liquids prepared in Examples 16 to 19.

TABLE 5

| | | Example | Example | Example | Example | Example |
|---|---|---|---|---|---|---|
| | | 15 | 16 | 17 | 18 | 19 |
| Composition | Composite | Composite | Composite | Composite | Composite | Composite |
| | pigment | pigment 9 | pigment | pigment | pigment | pigment |
| | | | 10 | 11 | 12 | 13 |
| | | 4 | 4 | 4 | 4 | 4 |
| | Resin for | 1.2 | 1.2 | 1.2 | 1.2 | 1.2 |
| | dispersion | | | | | |
| | Triethylene | 2.0 | 2.0 | 2.0 | 2.0 | 2.0 |
| | glycol | | | | | |
| | monobutyl | | | | | |
| | ether | | | | | |
| | 5% Aqueous | 4.4 | 4.4 | 4.4 | 4.4 | 4.4 |
| | potassium | | | | | |
| | hydroxide | | | | | |
| | solution | | | | | |
| | Ion exchange | 21.4 | 21.4 | 21.4 | 21.4 | 21.4 |
| | water | | | | | |
| Water-based | N.V. | 16.4 | 15.3 | 16.7 | 15.7 | 16.4 |
| pigment | Name | Water- | Water- | Water- | Water- | Water- |
| dispersion | | based | based | based | based | based |
| | | pigment | pigment | pigment | pigment | pigment |
| | | dispersion 6 | dispersion 7 | dispersion 8 | dispersion 9 | dispersion |
| | | | | | | 10 |
| Recording | Water-based | 6.2 | 7.2 | 6.1 | 7.0 | 7.4 |
| liquid | pigment | | | | | |
| | dispersion | | | | | |
| | Glycerin | 2.3 | 2.3 | 2.3 | 2.3 | 2.3 |
| | Triethylene | 1.1 | 1.0 | 1.1 | 1.0 | 1.0 |
| | glycol | | | | | |
| | monobutyl | | | | | |
| | ether | | | | | |
| | Surfinol 465 | 0.15 | 0.15 | 0.15 | 0.15 | 0.15 |
| | Ion exchange | 5.3 | 4.4 | 5.4 | 4.6 | 4.2 |
| | water | | | | | |
| | Name | Recording | Recording | Recording | Recording | Recording |
| | | liquid 6 | liquid 7 | liquid 8 | liquid 9 | liquid 10 |
| Evaluation of | Difference in | 55.7 | 53.9 | 60.0 | 56.7 | 51.2 |
| light resistance | ΔE | | | | | |
| | Evaluation | A | A | A | A | A |

### Reference Example 10

In a 100-mL plastic bottle, 4 parts of the polymer-coated pigment (d-5), 1.2 parts of the copolymer A-1 serving as a resin for dispersion, 4.4 parts of a 5% aqueous potassium hydroxide solution, 2.0 parts of triethylene glycol monobutyl ether, 8.4 parts of ion exchange water, and zirconia beads having a diameter of 0.5 mm were charged and mixed. The resulting mixed liquid was dispersed with a paint conditioner for two hours. After the completion of the dispersion, 13 parts of ion exchange water was added to the resulting dispersion liquid, and the zirconia beads were removed. The liquid was subjected to centrifugal separation (6,000 G, 30 minutes) to remove coarse particles. Thus, Reference water-based pigment dispersion 1 was prepared. Next, 6.1 parts of Comparative water-based pigment dispersion 1 prepared above, 1.8 parts of glycerin, 1.2 parts of triethylene glycol monobutyl ether, 0.2 parts of Surfinol 465 (manufactured by Air Products and Chemicals, Inc.), and 5.8 parts of ion exchange water were mixed to prepare Reference recording liquid 1.

### Reference Example 11

In a 1-L flask, 10 parts of C. I. Pigment Yellow 74 serving as a pigment, 9.7 parts of zinc acetylacetonate, and 380 parts of ethanol were charged, and the temperature was increased to 80° C. while stirring. A sodium hydroxide solution prepared by dissolving 3.3 parts of sodium hydroxide (in an amount of two times the number of moles of zinc acetylacetonate) in 127 parts of ethanol was added to the flask at a rate at which the liquid temperature of the reaction liquid did not substantially change. The reaction liquid was allowed to react at 80° C. for four hours. After the completion of the reaction, filtration was performed by using filter paper. The resulting reaction product was washed with water and methanol, and then dried with a hot-air dryer at 100° C. for six hours. The dried product was crushed with an Absolute mill. Thus, Reference composite pigment 2 in which zinc oxide particles adhered to the surface of the pigment was prepared.

In a 100-mL plastic bottle, 6.8 parts of Reference composite pigment 2 prepared above, 1.2 parts of the copolymer A-1 serving as a resin for dispersion, 4.4 parts of a 5% aqueous potassium hydroxide solution, 2.0 parts of triethylene glycol monobutyl ether, 8.4 parts of ion exchange water, and zirconia beads having a diameter of 0.5 mm were charged and mixed. The resulting mixed liquid was dispersed with a paint conditioner for two hours. After the completion of the dispersion, 13 parts of ion exchange water was added to the resulting dispersion liquid, and the zirconia beads were removed. The liquid was subjected to centrifugal separation (6,000 G, 30 minutes) to remove coarse particles. Thus, Reference water-based pigment dispersion 2 was prepared. Next, 6.8 parts of Reference water-based pigment dispersion 2 prepared above, 2.3 parts of glycerin, 1.1 parts of triethylene glycol monobutyl ether, 0.2 parts of Surfinol 465 (manufactured by Air Products and Chemicals, Inc.), and 4.7 parts of ion exchange water were mixed to prepare Reference recording liquid 2.

Table 6 shows the amounts mixed and evaluation results of the reference recording liquids prepared in Reference Examples 10 and 11.

TABLE 6

| | | Reference | Reference |
|---|---|---|---|
| | | Example 10 | Example 11 |
| Water- | Pigment | D-5 | Reference |
| based | | | composite |
| pigment | | | pigment 1 |
| dispersion | | 4.0 | 4.0 |
| | Resin for dispersion | 1.2 | 1.2 |
| | Triethylene glycol | 2.0 | 2.0 |
| | monobutyl ether | | |
| | 5% Aqueous potassium | 4.4 | 4.4 |
| | hydroxide solution | | |
| | Ion exchange water | 21.4 | 21.4 |
| Water- | N.V. | 15.0 | 15.4 |
| based | Name | Reference | Reference |
| pigment | | water-based | water-based |
| dispersion | | pigment | pigment |
| | | dispersion 1 | dispersion 2 |
| Recording | Water-based pigment | 6.1 | 6.8 |
| liquid | dispersion | | |
| | Glycerin | 1.8 | 2.3 |
| | Triethylene glycol | 1.2 | 1.1 |
| | monobutyl ether | | |
| | Surfinol 465 | 0.2 | 0.2 |
| | Ion exchange water | 5.8 | 4.7 |
| | Name | Reference | Reference |
| | | recording | recording |
| | | liquid 1 | liquid 2 |
| Pigment | Zinc oxide/pigment | 0 | 30% addition |
| composition | | | |
| Evaluation | Difference in ΔE | 44.9 | 43.0 |
| of light | Evaluation | B | B |
| resistance | | | |

### Evaluation/Measurement Methods

### [Method for Measuring Particle Diameters of Pigment and Zinc Oxide]

Primary particle diameters of pigments and zinc oxide of the composite pigments synthesized in Examples 6 to 14 were calculated by small-angle X-ray scattering using an X-ray diffractometer (TTRII, manufactured by Rigaku Corporation) (analysis software, rigaku NANO-Solver).

### [Evaluation of Light Resistance]

Printing was conducted with an ink-et printer by using the recording liquids prepared in Examples 15 to 19, recording liquids prepared in Reference Examples 10 and 11, and Comparative recording liquids 1 to 5. A drawing was printed on a recording medium with a piezo ink-jet printer (PX-G930, manufactured by Seiko Epson Corporation) by using the ink samples. “Glossy Photo Paper” manufactured by Seiko Epson Corporation was used as the recording medium.

The hue of the printed matter was measured with a spectrophotometer (SpectroEye, a product manufactured by GretagMacbeth). Regarding the measurement mode, a light source of D50, an absolute white base, an observation field of view of 2°, no filter, and a density standard of DIN NB were used.

The prepared printed matter was irradiated with ultraviolet light for 168 hours by using a light resistance tester (SUNTEST CPS+, manufactured by Atlas Material Testing Solutions, xenon lamp, irradiation intensity: 765 Wm). Subsequently, the hue of the printed matter was measured again by the same method. A color difference (ΔE*ab) was calculated from the above results.

The superiority and inferiority of light resistance was determined as follows. Comparative recording liquid 1 had the lowest light resistance and thus had the largest ΔE. Accordingly, the light resistance was determined as a difference in ΔE from Comparative recording liquid 1 (ΔE (Comparative recording liquid 1)−ΔE (sample)) by using ΔE of Comparative recording liquid 1 as a standard. The larger the difference in ΔE, the better the light resistance and the smaller the change in the hue from the time of the start of the light resistance test. When the difference in ΔE was 50 or more, the sample was evaluated as “A”. When the difference in ΔE was 30 or more and less than 50, the sample was evaluated as “B”. When the difference in ΔE was 10 or more and less than 30, the sample was evaluated as “C”. When the difference in ΔE was 10 or less, the sample was evaluated as “D”. Table 7 below shows the results of Comparative recording liquids 1 to 5 (Comparative Examples 6 to 10).

TABLE 7

| | | Comparative | Comparative | Comparative | Comparative | Comparative |
|---|---|---|---|---|---|---|
| | | Example 6 | Example 7 | Example 8 | Example 9 | Example 10 |
| Evaluation | Name | Comparative | Comparative | Comparative | Comparative | Comparative |
| of light | | recording | recording | recording | recording | recording |
| resistance | | liquid 1 | liquid 2 | liquid 3 | liquid 4 | liquid 5 |
| | Zinc oxide/ | 0% | 11% addition | 25% addition | 10% addition | 20% addition |
| | pigment | | | | | |
| | Difference in ΔE | 0 | 8.0 | 13.3 | 6.4 | 1.3 |
| | Evaluation | D | D | C | D | D |

### INDUSTRIAL APPLICABILITY

According to the composite pigment of the present invention, the hue of the pigment is not easily changed and the pigment has good light resistance. Therefore, the composite pigment of the present invention can be suitably used in an ink, a coating material, and a colorant for a resin, and in particular, suitably used in an ink for ink-jet printing.

1. A composite pigment comprising a pigment (A) and a zinc oxide particle adhering to a surface of the pigment.

2. A composite pigment comprising:
a polymer-coated pigment (D) including a pigment (A), a (co)polymer (B) of a polymerizable unsaturated monomer, and a (co)polymer obtained from at least one polymerizable unsaturated monomer (C) that is soluble in a non-aqueous solvent and becomes either insoluble or slightly soluble after polymerization, the (co)polymer (B) and the (co)polymer being disposed on a surface of the pigment (A); and a zinc oxide particle adhering to a surface of the polymer-coated pigment.

3. The composite pigment according to claim 1, wherein the zinc oxide particle has a diameter of 50 nm or less.

4. A method for producing a composite pigment comprising precipitating a zinc oxide fine particle on a surface of a pigment (A) by reacting, in the presence of the pigment (A), a reaction liquid from which zinc oxide is precipitated.

5. A method for producing a composite pigment comprising:
obtaining a polymer-coated pigment (D) by mixing a pigment (A), a non-aqueous solvent, and a (co)polymer (B) of a polymerizable unsaturated monomer, and then polymerizing, in the presence of the pigment (A), the non-aqueous solvent, and the (co)polymer (B) of the polymerizable unsaturated monomer, at least one polymerizable unsaturated monomer (C) that is soluble in the non-aqueous solvent and becomes either insoluble or slightly soluble after polymerization; and
precipitating a zinc oxide fine particle on a surface of the pigment by reacting, in the presence of the polymer-coated pigment (D), a reaction liquid from which zinc oxide is precipitated.

6. A method for producing a composite pigment comprising:
obtaining a polymer-coated pigment (D-1) by mixing a pigment (A), a non-aqueous solvent, and a polymerizable unsaturated group-containing (co)polymer (B-1) of a polymerizable unsaturated monomer, and then copolymerizing the (co)polymer (B-1) of the polymerizable unsaturated monomer with at least one polymerizable unsaturated monomer (C) that is soluble in the non-aqueous solvent and becomes either insoluble or slightly soluble after polymerization; and
precipitating a zinc oxide fine particle on a surface of the pigment by reacting, in the presence of the polymer-coated pigment (D-1), a reaction liquid from which zinc oxide is precipitated.

7. The method for producing a composite pigment according to claim 4, wherein the zinc oxide particle has a diameter of 50 nm or less.

8. A composite pigment produced by the method according to claim 4.

9. A recording liquid comprising the composite pigment according to claim 1.

10. The recording liquid according to claim 9, wherein the recording liquid is an ink for ink-jet printing.
